(19) United States
(12) Patent Application Publication
(10) Pub. No.: US 2014/0000059 A1
(43) Pub. Date: Jan. 2, 2014

(54) WINDSCREEN WIPER DEVICE

(71) Applicant: Thomas Friscioni, Aumetz (FR)

(72) Inventor: Thomas Friscioni, Aumetz (FR)

(21) Appl. No.: 13/983,129

(22) PCT Filed: Feb. 1, 2011
(86) PCT No.: PCT/EP2011/051415

§ 371 Date: Sep. 17, 2013

(51) Int. Cl. B60S 1/38; B60S 1/04

(52) U.S. Cl. CPC B60S 1/3848; B60S 1/0408
USPC 15/250.201

(57) ABSTRACT

A windscreen wiper device of the flat blade type comprising an elastic, elongated carrier element, as well as an elongated wiper blade comprising an elongated upper holding part and an elongated lower wiping part of a flexible material and a spoiler at a side of the upper holding part facing away from the lower wiping part, which windscreen wiper device further comprises a connecting device for an oscillating arm, with the special feature that lateral sides of the holding part, at a location of its free end facing towards an A-pillar of the windscreen to be wiped, is provided with a beveled surface having its lowest width facing towards the free end.

### BACKGROUND OF THE INVENTION

1. Technical Field

The present invention relates to a windscreen wiper device of the flat blade type comprising an elastic, elongated carrier element, as well as an elongated wiper blade, which can be placed in abutment with a windscreen to be wiped, the wiper blade comprising an elongated upper holding part and an elongated lower wiping part of a flexible material, wherein the upper holding part holds the wiping part and is provided with at least one longitudinal groove, in which groove at least one longitudinal strip of the carrier element is disposed, wherein the wiper blade comprises a spoiler at a side of the upper holding part facing away from the lower wiping part, which windscreen wiper device further comprises a connecting device for an oscillating arm, wherein the oscillating arm can be pivotally connected to the connecting device about a pivot axis near one end thereof, with the interposition of a joint part.

2. Related Art

Such a windscreen wiper device is generally known. The prior art windscreen wiper device is in particular designed as a “yokeless” wiper device or “flat blade”, wherein use is no longer made of several yokes pivotally connected to each other, but wherein the wiper blade is biased by often two longitudinal strips of the carrier element, as a result of which it exhibits a specific curvature. According to the prior art a connecting piece (in practice also called an “end cap”) is slided over neighboring ends of the strips—or vice versa, that is the neighboring ends of the strips are slided into the connecting piece—so that a reliable snap connection between these parts is realized. In the prior art the connecting piece is provided with an opening at its free end so that the wiper blade can freely slide through the connecting piece. In other words, the connecting pieces do not retain the wiper blade, so that the connecting pieces allow a relative movement of the wiper blade along the longitudinal strips in the connecting pieces.

One drawback of the prior art windscreen wiper device is the fact that, during oscillatory movements of the wiper blade, the connecting pieces may touch the respective A-pillars of the vehicle concerned, resulting in a rattling noise, air turbulence and sometimes in damages to the connecting pieces and/or longitudinal strips. As a result, the wiping properties may deteriorate, whereas the wiper blade may come loose from the connecting pieces, particularly when the wiper blade and the connecting pieces are not connected in a durable, solid manner. Hence, the life span of the prior art windscreen wiper device may be seriously shortened.

### SUMMARY OF THE INVENTION

The object of the invention is to improve the prior art as indicated above, in particular to provide a windscreen wiper device, wherein the wiping properties are improved.

In order to accomplish that objective, a windscreen wiper device of the kind referred to in the introduction according to the invention is characterized in that lateral sides of the holding part, at a location of its free end facing towards an A-pillar of the windscreen to be wiped, is provided with a beveled surface having its lowest width facing towards the free end. Particularly, the ratio between the lowest width of the holding part at a location facing towards the free end and the highest width of the holding part at a location facing away from the free end varies between 25 and 8, particularly between 20 and 8.

Preferably, the lateral sides of the holding part are cut to obtain the beveled surface.

It is noted that the present invention is not restricted to windscreen wiper devices for cars, but that it also relates to windscreen wiper devices for rail coaches and all other (fast) vehicles.

In a preferred embodiment of a windscreen wiper device in accordance with the invention a free end of the spoiler, facing towards an A-pillar of the windscreen to be wiped, is provided with a beveled surface, wherein the height of the spoiler decreases along the beveled surface, seen from the windscreen to be wiped. Preferably, the ratio between the height of the spoiler at a side thereof facing towards the windscreen to be wiped and the height of the spoiler at a side thereof facing away from the windscreen to be wiped varies between 35 and 5, particularly between 22 and 8.

In another preferred embodiment of a windscreen wiper device according to the invention the free end of the spoiler is cut to obtain the beveled surface.

In a further preferred embodiment of a windscreen wiper device in accordance with the invention the wiper blade does not comprise a connecting piece at its end facing towards an A-pillar of the windscreen to be wiped. Consequently, the free end of the spoiler and the lateral sides of the holding part do not contain any end cap.

### THE DRAWINGS

The invention will now be explained in more detail with reference to figures illustrated in a drawing, wherein: FIG. 1 is a total perspective, schematic view of a windscreen wiper device according to the invention;

FIGS. 2, 3 and 4 are a perspective view and side views of parts of a wiper blade equipped with a spoiler, as used in the windscreen wiper device of FIG. 1; and

FIG. 5 shows the effect of the invention (above) compared to the prior art (below).

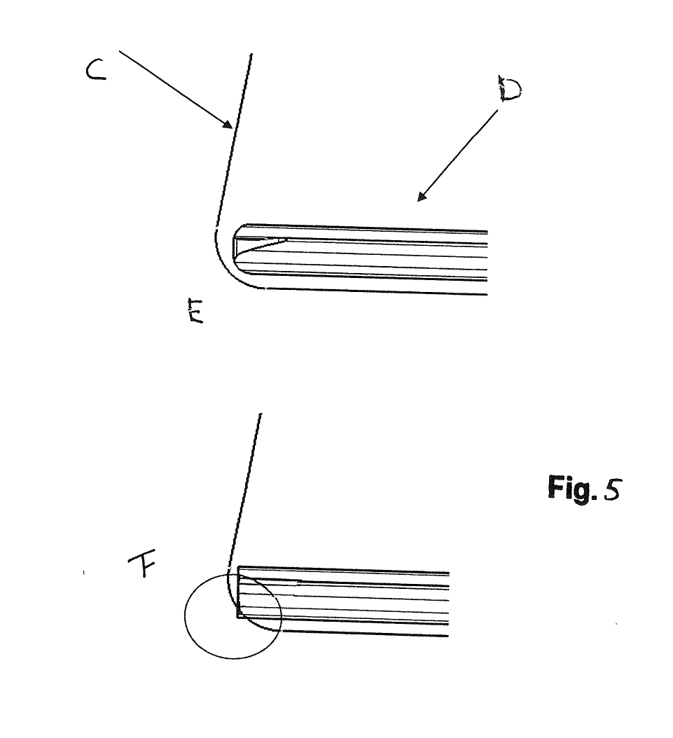

### DETAILED DESCRIPTION

FIG. 1 shows a preferred variant of a windscreen wiper device 1 according to the invention. The windscreen wiper device 1 is built up of an elastomeric wiper blade 2, wherein a central longitudinal groove 3 is formed, and of a central longitudinal strip 4 made of spring band steel, which is fitted in the longitudinal groove 3. the strip 4 forms a flexible carrier element for the rubber wiper blade 2, as it were, which is thus biased in a curved position (the curvature in operative position being that of a windscreen to be wiped). Free ends 5 of the strip 4 and/or wiper blade 2 remain free, that is there are no connecting pieces or end caps connected thereto on either side of the windscreen wiper device 1. The windscreen wiper device 1 is furthermore built up of a connecting device 6 of plastic or metal material for an oscillating wiper arm. Connecting device 6 comprises clamping members 7 that are integral therewith, which engage round longitudinal sides of the wiper blade 2 that face away from each other, as a result of which the connecting device 6 is firmly attached to the unit consisting of wiper blade 2 and strip 4. The oscillating wiper arm is pivotally connected to the connecting device 6 about a pivot axis near one end, with the interposition of a joint part 16. The preferred embodiment of FIG. 1 according to the invention comprises a spoiler or “air deflector” 8 connected in its entirety to the wiper blade 2, wherein the spoiler 8 and the wiper blade 2 are in one piece.

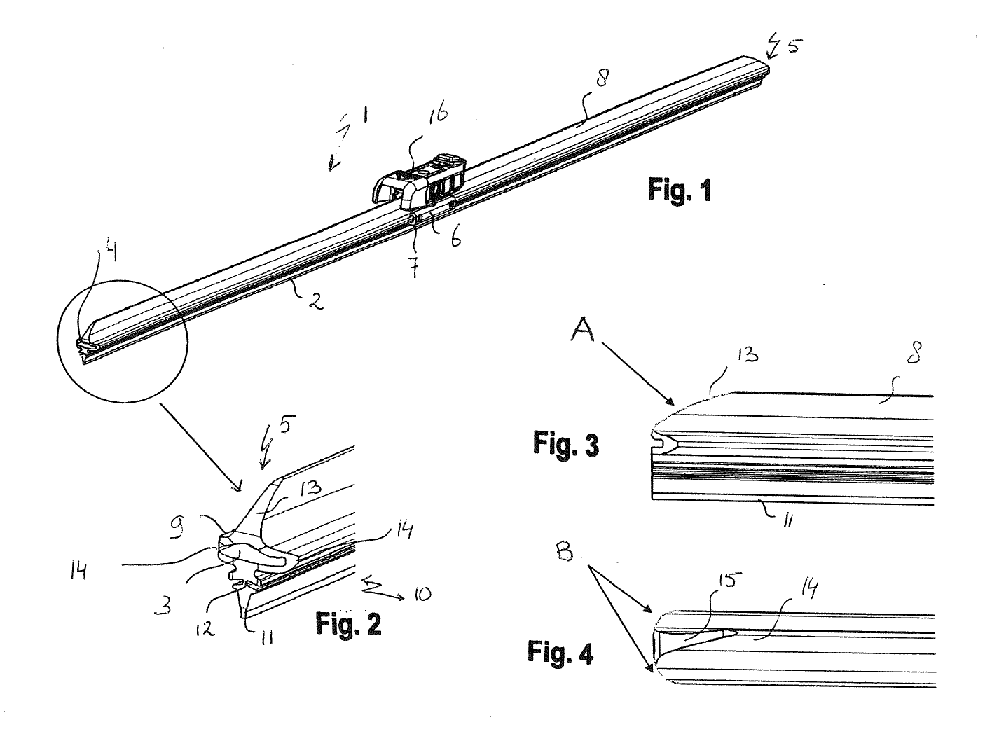

In FIGS. 2, 3 and 4 a perspective view and side views of the wiper blade 2 of FIG. 1 is shown, wherein corresponding parts have been designated with the same reference numerals. As can be seen from FIG. 2, the rubber wiper blade 2 consists of an elongated upper holding part 9 holding the longitudinal strip 4 in the groove 3 formed therein, an elongated lower wiping part 10 having a wiping lip 11, as well as an intermediate “strip-like” titling web 12 interconnecting the holding part 9 and the wiping part 10. The holding part 9, the wiping part 10 and the tilting web 12 are in one piece of rubber. As can be seen in FIG. 2, the wiper blade 2 comprises a spoiler 8 at a side thereof facing away from the windscreen to be wiped, wherein a free end of the spoiler 8, facing towards an A-pillar of the windscreen to be wiped, is provided with a beveled surface 13. As shown, the height of the spoiler 8 decreases along the beveled surface 13, seen from the windscreen to be wiped. Further, lateral sides 14 of the holding part 9, at a location of its free end facing towards the A-pillar of the windscreen to be wiped, is also provided with a beveled surface 15. The lateral sides 14 of the holding part 9 are cut to obtain the beveled surface 15.

Although not shown in FIGS. 1 and 2, but fully understood by a skilled person, the oscillating arm is connected to a mounting head fixed for rotation to a shaft driven by a small motor. In use, the shaft rotates alternately in a clockwise and in a counter-clockwise sense carrying the mounting head into rotation also, which in turn draws the oscillating arm into rotation and by means of the connecting device 6 moves the wiper blade 2.

The invention is not restricted to the embodiments shown, but also extends to other preferred embodiments falling within the scope of the appended claims.

1-4. (canceled)

5. A windscreen wiper device of the flat blade type comprising an elastic, elongated carrier element, as well as an elongated wiper blade, which can be place din abutment with a windscreen to be wiped, said wiper blade comprising an elongated upper holding part and an elongated lower wiping part of a flexible material, wherein said upper holding part holds said wiping part and is provided with at least one longitudinal groove, in which groove at least one longitudinal strip of the carrier element is disposed, wherein said wiper blade comprises a spoiler at a side of said upper holding part facing away from said lower wiping part, which windscreen wiper device further comprises a connecting device for an oscillating arm which can be pivotally connected to said connecting device about a pivot axis near one end thereof, with the interposition of a joint part, wherein lateral sides of said holding part, at a location of its free end facing towards an A-pillar of the windscreen to be wiped when in a use position on a vehicle , is provided with a bevelled surface having its lowest width facing towards said free end, wherein the lateral sides of said holding part are cut to obtain the bevelled surface, wherein a free end of said spoiler facing towards the A-pillar of the windscreen to be wiped, when in the use position on a vehicle, is provided with a bevelled surface, wherein the height of said spoiler decreases along said bevelled surface, seen from the windscreen to be wiped, wherein the free end of said spoiler is cut to obtain the bevelled surface.

6. The windscreen wiper device according to claim 5, wherein the ratio between the lowest width of said holding part at a location facing towards said free end and the highest width of said holding part at a location facing away form said free end varies between 25 and 8.

7. The windscreen wiper device according to claim 5, wherein the ratio between the height of said spoiler at a side thereof facing towards the windscreen to be wiped and the height of said spoiler at a side thereof facing away from the windscreen to be wiped, varies between 35 and 5.

8. The windscreen wiper device according to claim 5, wherein the free end of said wiper blade does not comprise a connecting piece or “end cap”.

9. The windscreen wiper device according to claim 6, wherein said ratio is between 20 and 8.

10. The windscreen wiper device according to claim 7, wherein said ratio is between 22 and 8.
